(19) United States
(12) Patent Application Publication
(10) Pub. No.: US 2025/0339835 A1
(43) Pub. Date: Nov. 6, 2025

(54) COMPOSITE SORBENT MATERIAL

(71) Applicant: ASTON UNIVERSITY, Birmingham (GB)

(72) Inventors: Ahmed Rezk, Birmingham (GB); Zoran Visak, Birmingham (GB)

(21) Appl. No.: 18/866,275

(22) PCT Filed: May 10, 2023
(86) PCT No.: PCT/EP2023/062339

§ 371 Date: Nov. 15, 2024

(30) Foreign Application Priority Data
May 17, 2022 (GB) 2207186.4

(51) Int. Cl. B01J 20/20; B01J 20/28; B01J 20/32

(52) U.S. Cl. CPC B01J 20/205; B01J 20/28004; B01J 20/28011; B01J 20/28016; B01J 20/3204; B01J 20/3287; B01J 20/3293

(57) ABSTRACT

A composite sorbent material comprising a few-layer 2D carbon allotrope impregnated with an ionic liquid is described. Also described are a method for producing said material, a composite material comprising said material, and the use of said material for thermal energy storage, sorption cooling, adsorption water desalination or air dehumidification

### FIELD OF THE INVENTION

The present invention relates to a composite sorbent material, and particularly, although not exclusively, to a composite sorbent material that may find particular utility for thermal energy storage applications.

### BACKGROUND

Solid physical sorbents (i.e., adsorbents), chemical sorbents (i.e., absorbents), and physical/chemical sorbent composites have many uses. However, in recent times, their potential for use in the field of thermal energy storage has come to light, in view of their potential for high heat storage density and the absence of heat leakage during the storage phase (as thermal energy is stored in the form of sorption potential, not heat).

Despite the significant amount of scientific progress in this area, one consistent problem that arises in respect of use of sorbent materials for thermal energy storage is that the heat charging and discharging rates of many sorbent materials can be slow, due to the typical poor thermal diffusivity (i.e., heat transfer rate) of many known sorbent materials. Slow heat charging and discharging rates impede the thermal energy storage process, thus limiting the commercial potential for this technology.

For example, conventionally, porous mediums (e.g., silica gel, zeolite, metal organic framework, activated carbon, expandable graphite, graphite) have been used as host structures for chemical sorbents. For example, L. W. Wang et al, “Thermal conductivity and permeability of consolidated expanded natural graphite treated with sulphuric acid” investigates the thermal conductivity and permeability of consolidated expanded natural graphite treated with sulphuric acid, for consideration of its effectiveness for use as a heat transfer matrix. A. Grekova et al, “Composite sorbents “Li/Ca halogenides inside Multi-wall Carbon Nano-tubes” for Thermal Energy Storage” considers the use of composites Multi-Wall Carbon Nanotubes (MWCNT) impregnated with three specific hygroscopic salts. However, whilst these known hosting structures have exceptional surface areas and porous volumes, their thermal diffusivity is still not sufficient, and negates their advanced adsorption performance. Furthermore, often the physical form of these materials is not ideal—e.g. in the Wang et al. reference noted above, the material is in the form of a compressed disc, which is not practical for use in many industrial applications, primarily due to the low permeability and the produced shape.

It would be advantageous to provide a sorbent material suitable for use in thermal energy storage applications, as well as other applications which involve cyclical heating/cooling and (e.g., adsorption cooling, adsorption water desalination and air dehumidification), which provide improved performance, and/or have a more convenient physical form for use in such applications.

The present invention has been devised in light of the above considerations.

### SUMMARY OF THE INVENTION

The present inventors have realised that it may be possible to produce high-performance composite materials by using specific 2D materials as host structures for selected chemical sorbent materials.

Accordingly, in a first aspect, the present invention provides a composite sorbent material comprising a few-layer 2D carbon allotrope impregnated with an ionic liquid. The 2D carbon allotrope acts as a host/matrix structure for the ionic liquid. Accordingly, the term “host structure”, “host material” “matrix material” or “matrix structure” may also be used interchangeably in the following disclosure in order to refer to the 2D carbon allotrope material into which the ionic liquid is impregnated. The ionic liquid may be intercalated between layers of the 2D carbon allotrope.

The present inventors have found that by impregnating a few-layer 2D carbon allotrope with an ionic liquid, sorbent materials having excellent sorbent performance can be provided. Furthermore, the resultant sorbent materials are found to have improved thermal diffusivity in comparison to thermal diffusivity of other known physical sorbent materials such as graphite, metal organic framework and silica gel powders. Accordingly, such materials offer strong potential for use in applications such as thermal energy storage, and more generally, in any applications requiring cyclical heating and cooling.

The term “2D carbon allotrope” is used herein to define materials have a substantially two-dimensional structure and consisting essentially of carbon.

Suitable 2D carbon allotropes may include one or more materials selected from the group including: graphene, graphyne, graphyenylene, diamane, and mixtures thereof. Accordingly, the 2D carbon allotrope used in the present invention may comprise or consist of one or more of the above identified materials. It is considered that such 2D carbon allotropes may offer improved performance in comparison to materials having a substantially 3D structure—for example, graphite (including expandable graphite). It is preferred that the composite sorbent materials according to the present invention do not comprise graphite or expandable graphite.

The term “few-layer” is used to generally refer to a material having a thickness of less than 10 atomic layers. For example, the material may comprise between 1 and 10 atomic layers (e.g. 1, 2, 3, 4, 5, 6, 7, 8, 9 or 10 atomic layers). In preferred arrangements, the material may have a thickness of 5 atomic layers or less. Atomic layers here generally refers to monoatomic layers. The number of layers may be measured by any suitable technique known in the art, including but not limited to e.g. transmission electron microscopy (TEM) or atomic force microscopy (AFM). Materials having fewer atomic layers may be preferred as they may have improved properties with respect to thermal diffusivity as compared with materials having more layers.

The few-layer 2D carbon allotrope may be in the form of platelets. The size of platelets is not particularly limited, however in some embodiments, the platelets may have a lateral extent in a range of from 0.5 nm to 20 μm. For example, the platelets may have a lateral extent of 1 nm or more, 5 nm or more, 10 nm or more, 50 nm or more, 100 nm or more, 200 nm or more, 500 nm or more, 1 μm or more, or 5 μm or more. The platelets may have a lateral extent of 15 μm or less, 10 μm or less, 5 μm or less, or 1 μm or less. In general, smaller particles will typically have a greater overall surface area, for the same bulk volume of particles.

The two longest dimensions of the platelets may each be at least about 10 times greater, or at least about 50 times greater, or at least about 100 times greater, or at least about 1000 times greater, or at least about 5000 times greater, or at least about 10,000 times greater than the shortest dimension (i.e. thickness) of the platelets. The size of the few-layer 2D carbon allotrope platelets may be determined by any suitable method known in the art, e.g. by SEM or TEM analysis.

In some preferred embodiments, the 2D carbon allotrope comprises, or consists of, graphene. Graphene can be obtained or prepared according to any technique apparent to those of skill in the art. For example, it can be obtained from natural or synthetic graphite, graphite oxide, expandable graphite, expanded graphite, etc. It can be obtained by the physical exfoliation of graphite, by for example, peeling, grinding, or milling off graphene from the graphite. It can be made from inorganic precursors, such as silicon carbide. It can be made by chemical vapor deposition (such as by reacting a methane and hydrogen on a metal surface). It can be made by the reduction of an alcohol, such ethanol, with a metal (such as an alkali metal like sodium) and the subsequent pyrolysis of the alkoxide product. It can be made by the exfoliation of graphite in dispersions or exfoliation of graphite oxide in dispersions and the subsequently reducing the exfoliated graphite oxide. Graphene can be made by the exfoliation of expandable graphite, followed by intercalation, and ultrasonication or other means of separating the intercalated sheets. It can be made by the intercalation of graphite and the subsequent exfoliation of the product in suspension, thermally, etc. Further useful processes include those described or referenced in F. Bonaccorso et al, Materials Today (2012) 15, 564-589; A. C. Ferrari et al., Nanoscale, (2015), 7, 4598-4810.

In preferred embodiments, the composite sorbent material comprises few-layer graphene (FLG) as a matrix of the composite (in other words, as a host structure for the ionic liquid). FLG are composed of several stacked graphene layers, typically between 2 and 6 layers. As noted above, the few-layer graphene (FLG) may comprise less than 10 atomic layer graphene sheets. For example, the FLG may comprise 1-6 atomic layer graphene sheets. The FLG may be composed of pure carbon, or substantially composed of pure carbon. Alternatively, the FLG may comprise one or more trace elements, for example elements selected from the group consisting of nitrogen, boron, oxygen and hydrogen, and combinations thereof. Preferably, the FLG comprises at least 98% carbon, at least 99% carbon, at least 99.5% carbon, or at least 99.9% carbon.

The term “ionic liquid” is a term of art used to define salts which are in a liquid state. The term ionic liquid is typically used to refer to a salt usually having a melting point of 100° C. or less. However, in some cases, the term is used to refer to salts which are liquid at, or near to, room temperature (i.e. which are liquid in a range of from about 10° C. to about 40° C., or in a range of from about 20° C. to about 30° C.). Accordingly, the melting point of the ionic liquid(s) used in the present invention is preferably 100° C. or less, more preferably 80° C. or less, more preferably 70° C. or less, more preferably 60° C. or less, more preferably 50° C. or less, or more preferably 40° C. or less.

lonic liquids consist essentially of ions (cations and anions). lonic liquids may in some applications be referred to as liquid electrolytes, ionic melts, ionic fluids, fused salts, liquid salts or molten salts. The ionic liquid may comprise at least one ion having a delocalized charge. It may further comprise at least one organic ion.

One advantage of the use of ionic liquids, in particular, is that the characteristics (ionic structure) of the ionic liquid which is impregnated into the few-layer 2D material can be specifically tailored for the intended application. For example, Mehrkesh, Amirhossein & Karunanithi (2016), as well as Gao et al. (2015) and Seo et al. (2014) explain how through appropriate selection of cations, anions and aliphatic alkyl side chain groups usually attached to the cation, ILs can be tuned to impart specific functionality for a given application. A further advantage is that due to their relatively low melting points, crystallisation of these liquids during use can be more easily avoided, leading to reduced risk of damage to the host matrix material into which the liquid is impregnated as a result of unwanted crystallisation of the liquid during use. A yet further advantage is the superior thermal diffusivity of ionic liquids as compared with other salt hydrates (for example, salt hydrates such as LiCl). It has been found that impregnating a few-layer 2D carbon allotrope with ionic liquids can provide composite sorbent materials having surprisingly good thermal diffusivity in comparison to analogous composites which do not comprise an ionic liquid but which comprise a salt hydrate such as LiCl.

The ionic liquid may comprise a cation comprising one or more aromatic rings. Alternatively or additionally, the ionic liquid may comprise a nitrogen-containing cation. Alternatively or additionally, the ionic liquid may comprise a phosphorus-containing cation. In preferred arrangements, the ionic liquid may comprise cation(s) selected from the group consisting of: imidazolium, pyridinium, pyrrolodinium, ammonium or phosphonium cations.

The ionic liquid may comprise anion(s) selected from the group consisting of: tetrafluoroborate [BF₄]⁻, hexafluorophosphate [PF₆]⁻, Chloride [Cl]⁻, Bromide [Br]⁻, Methylsulfate [CH3OSO3]⁻, methanesulfonate [CH₃SO₃]⁻, Trifluoromethanesulfonate [CF₃SO₃]⁻, bis(trifluoromethylsulfonyl) imide [(CF₃SO₂)₂]⁻, Benzoate [C₇H₅O₂]⁻, Nitrate [NO₃]⁻, or Acetate [C₂H₃O₂]⁻ anions. The use of Cl⁻, Br⁻, triflate, and methanesulfonate anions may be particularly preferred in view of their performance in allowing sorption of water in ionic liquids including these anions—i.e. in view of the typically hydrophilic nature of these anions. More generally, the use of hydrophilic anions may be preferred in comparison to hydrophobic anions.

In some arrangements, the ionic liquid may comprise a mixture or two of more ionic liquids. In other words, the ionic liquid may comprise two or more different cations, and/or two or more different anions. The ionic liquid may be a binary mixture of two ionic liquids—also referred to in the art as a ‘double salt ionic liquid’ (DSIL). It is also contemplated that ternary or higher order mixtures of ionic liquids may be suitable for use in the present invention.

The ionic liquid may comprise one or more aliphatic side chains. The aliphatic side chains may be provided on the cation and/or anions forming the ionic liquid but are more typically provided on the cations. These aliphatic chains may be linear, branched or may form a non-aromatic ring, although a linear aliphatic groups may be preferred. The aliphatic side chains may comprise one or more alkyl groups selected from the group consisting of: methylene [CH₂], methyl [CH₃], ethyl [C₂H₅], propyl [C₃H₇], butyl [C₄H₉], Benzyl [C₆H₅CH₂], Methoxy [OCH₃], ethoxy [OC₂H₅], propoxy [OC₃H₇], butoxy [OC₄H₉], or hydroxyl [OH]. For example, one preferred cation is ethyl-methylimidazolium, which comprises an imidazolium ion having both ethyl and methyl alkyl side chain groups.

Preferred side chain groups may be dependent on the intended application of the composite sorbent material. For example, absorption and solubility of water in ionic liquids may be dependent on the hydrophobicity of any cation aliphatic side chains that are present (this can vary depending on the length of the aliphatic chain—the longer the chain the lower the hydrophilicity), and so the use of short aliphatic side chains (e.g. C4 or shorter) may be preferred in order to give an improved performance in water absorption. However, longer aliphatic side chains (e.g. up to, or in some cases greater than C4 in length) may nevertheless provide suitable performance for absorption and solubility of ethanol, as this alcohol also has an aliphatic chain so it would support its absorption (and solubility) in ionic liquid.

Suitable ionic liquids may include but are not limited to: 1-ethyl-3-methylimidazolium methanesulfonate (EMIM CH₃SO₃), 1-ethyl-3-methylimidazolium-chloride (EMIM Cl), 1-ethyl-3-methylimidazolium methylsulfate (EMIM CH₃OSO₃), 1-ethyl-3-methylimidazolium trifluoromethanesulfonate (EMIM CF₃SO₃). Accordingly, the ionic liquid used in the present invention may be selected from one or more of these ionic liquids, or mixtures thereof, e.g. binary mixtures thereof.

The ionic liquid may be impregnated into the host structure provided by the few-layer 2D carbon allotrope by any suitable method known in the art.

Accordingly, in a second aspect, the present invention provides a method for producing a composite sorbent material, the method including steps of:
providing a few-layer 2D carbon allotrope; and
impregnating the 2D carbon allotrope with an ionic liquid to form the composite sorbent material.

The use of a wet impregnation (WI) method to develop the composite is preferred, because such methods may provide for high levels of both interfacial and bulk deposition of the ionic liquid onto the host material (2D carbon allotrope, in the present invention). However, the use of other impregnation approaches (e.g., Incipient Wetness Impregnation (IWI) and Equilibrium Deposition Filtration (EDF)) are also contemplated. It is noteworthy that Incipient Wetness Impregnation may attain more bulk deposition and Equilibrium Deposition Filtration attains more interfacial deposition as reported by (Bourikas 2006).

A wet impregnation method may include a step of immersing the matrix material (here, the 2D carbon allotrope) into a solution comprising the ionic liquid in a solvent for impregnation in the matrix material. The solution comprise the ionic liquid may be an aqueous solution, i.e. wherein the solvent is water.

The concentration of the ionic liquid in the aqueous solution may be in a range of from 1 wt % to 99 wt %, e.g. it may be about 10 wt %, about 20 wt %, about 30 wt %, about 40 wt %, about 50 wt %, or about 60 wt %. Higher concentrations of the ionic liquid in solution may result in a greater amount of ionic liquid being impregnated in the host structure. Accordingly, it may be preferred for the ionic liquid to be present in the solution an amount of at least 15 wt % or at least 20 wt %. Furthermore, it has been found that increasing the wt % of the ionic liquid in the solution which is impregnated into the matrix material may lead to improved sorption performance but reduced thermal diffusivity of the resulting composite. Accordingly, in preferred embodiments, the concentration of the ionic liquid in the aqueous solution which is impregnated into the matrix material to form the composite sorbent material is in a range of from 20 wt % to 30 wt %, for example around 25%—this amount has been found to give a good balance between sorption performance and thermal diffusivity.

The matrix material and solution comprising the ionic liquid may be mixed in a ratio of 1 g matrix material: 5 g solution or greater, e.g. a ratio of 1:10, 1:15, 1:20, 1:25, 1:50 or more. By providing an excess amount of solution compared with the amount of matrix material, it may be possible to ensure more complete impregnation of the matrix material.

The immersion step may be performed in order to attain a homogenous blend of host matrix/ionic liquid solution. The immersion step may be performed for a time of e.g. 1 minute or more, e.g. 10 minutes or more, 30 minutes or more, or 1 hour or more.

During immersion of the matrix material in the solution comprising the ionic liquid, stirring may be performed. This can help to ensure more complete impregnation of the matrix material.

Prior to the immersion step, the host matrix/structure may be dried in order to remove unwanted moisture or absorbed gases. The drying may be performed in an oven, or by any other suitable method. The drying may be performed at a temperature of 50° or more, 100° or more, or 150° or more. The drying may be performed for a time period of 1 hr or more, 2 hr or more, 5 hr or more, 10 hr ore more or 12 hr or more.

After the immersion step, the impregnated host matrix (composite material) may be separated from the mixture by any appropriate technique (e.g. a filtration step). The composite material may then be dried to remove excess solvent (e.g. to remove excess water).

A full example method is set out below:
a) Dry the host matrix/structure in an oven at 150° C. for 12 h.
b) Prepare the ionic liquid aqueous solution at excessive volume compared to the host structure in order to ensure achieving the wet impregnation (e.g., 1 g graphene: 25 g solution). The aqueous solution concentration can vary (e.g., 10 wt %, 20 wt %, 30 wt %, 40 wt %, 50 wt %, 60 wt %), as higher salt concentration attains higher salt impregnation.
c) Immerse the dried host matrix into the aqueous solution and stir it for nearly 1 hr to attain a homogenous blend of host matrix/aqueous solution.
d) Leave the mixture to rest for an hour to ensure the complete impregnation of the host matrix.
e) Filter the excess solution and dry the composite gently in the oven at 150° C. for at least 1 hr.

In some embodiments, the wt % (mass fraction) of the ionic liquid in the composite sorbent material may be at least 1% up to 60%, based on the total weight of the composite sorbent material. It has been found that increasing the wt % of the ionic liquid in the composite sorbent material may lead to improved sorption performance but reduced thermal diffusivity. For example, the ionic liquid may be present in a wt % of 1% or more, 2% or more, 3% or more, 5% or more, 10% or more, 15% or more, 20% or more, 30% or more, 40% or more or 50% or more. The wt % of ionic liquid in the composite material can be quantified according to the following equation:

$$IL content = \frac{{m}_{composite} - {m}_{dry matrix}}{{m}_{dry matrix}}$$

The estimate of IL liquid mass may be based on the measured density of the dry matrix, the final composite, and the density of ILs using the below formula:

$${ρ}_{composite} = \frac{{m}_{matrix} - {m}_{IL}}{\frac{{m}_{matrix}}{{ρ}_{matrix}} + \frac{{m}_{IL}}{{P}_{IL}}}$$

In some embodiments, the composite sorbent material has a thermal diffusivity of 3 mm²/s or more, more preferably 4 mm²/s or more, 5 mm²/s or more, 6 mm²/s or more, 7 mm²/s or more, 8 mm²/s or more, 9 mm²/s or more, or 10 mm²/s or more. In some embodiments, the composite sorbent material may have a thermal diffusivity of up to around 12 mm²/s or more. The thermal diffusivity may be measured by laser flash analyser, using a method as discussed in further detail below.

High thermal diffusivity can provide improved performance of the composite sorbent material when used in e.g. thermal energy storage applications or other applications which require heat cycling.

In some embodiments, the composite sorbent material may be particulate in form. That is, the composite sorbent material may comprise a plurality of particles. The particles may be formed as single discrete particles or may be formed as agglomerates including two or more smaller particles. The particles or agglomerate particles may have a size (largest dimension) of from about 5 to 70 μm, as measured by SEM imaging—e.g. by measuring the largest dimension of n platelets, and calculating a mean of the measured values, n being a value of 5 or more. In general, smaller particles will typically have a greater overall surface area, for the same bulk volume of particles. Accordingly, in preferred arrangements, the particles may have a size (largest dimension) of from about 5 to 50 μm—e.g. 50 μm or less, 40 μm or less, 30 μm or less, 20 μm or less or 10 μm or less. The particle size of the composite sorbent material may be primarily dependent on the particle size of the few-layer 2D carbon allotrope prior to impregnation.

Providing the composite sorbent material to be in powder form may have significant advantages over known sorbent materials that are provided as a bulk mass, because it can both facilitate industrial processes involving the material (e.g. facilitate the process of manufacturing a heat exchanger comprising the material). Furthermore, by providing the material in powder form, it may be possible to incorporate the material into other materials or articles—e.g. by incorporating the powder as a filler material in a matrix material to provide a further composite material. For example, the powder may be incorporated part of a coating for another material by combining the powder with a suitable binder material or packing it in binding foam, such as a metallic or graphite foam.

Accordingly in a further aspect of the present invention, there is provided a further composite material comprising the composite sorbent material of the first aspect in combination with one or more further materials.

The further composite material may have a matrix-filler structure, with the composite sorbent material of the first aspect acting as the filler material, in a matrix material of different composition.

In one preferred arrangement, there is provided a coating material comprising the composite sorbent material according to the first aspect of the invention, in combination with a binder material. Suitable binder materials are not particularly limited but may include epoxy-based binder materials, silicon-based binder materials, and/or polymeric binder materials. One example of a suitable binder material includes polyvinyl acetate (PVA). The coating material may be produced by mixing the composite sorbent material with the binder material in any suitable manner. The coating materials may be applied to other structures by any suitable method including e.g. dip coating or spray coating.

In another preferred arrangement, there is a metallic or graphite foam supporting the composite sorbent material. The composite sorbent material may be applied to the foam to be supported on it by any suitable method, including coating the foam (e.g. by dip or spray coating), or by granular packing of the composite sorbent material into the foam.

The composite material may find uses in many applications, including but not limited to thermal energy storage applications, sorption cooling, adsorption water desalination and air dehumidification.

Accordingly in a further aspect, the present invention provides the use of a composite sorbent material according to the first aspect for any of the above applications.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIGS. 1 (a) and (b) show the thermal diffusivity of composites according to the invention compared to a conventionally used silica gel adsorbent.

FIG. 2. shows water vapour adsorption characteristics of the developed composites compared to the conventionally used silica gel adsorbent, in the form of sorption isotherms.

FIG. 3 shows ethanol adsorption characteristics of the developed composites compared to the conventionally used silica gel adsorbent, in the form of sorption isotherms.

FIG. 4 shows a graph of uptake % against time indicating stability for water sorption for (a) GP-CL-10 and (b) GP-CL-20.

FIG. 5 shows a graph of uptake % against time indicating stability for water sorption for (a) GP-CH3SO3-10 and (b) GP-CH3SO3-20.

FIG. 6 shows SEM images of various samples of materials according to the present invention: (a) GP-CL-10; (b) GP-CH3SO3-10; (c) GP-CL-20; (d) GP-CH3SO3-20; (e) GP-CL-30; (f) GP-CH3SO3-30; (g) GP-CL-40; (h) GP-CH3SO3-40

FIG. 7 shows an SEM image of pristine graphene platelets used to form composite materials according to the present invention.

### EXAMPLES

### Synthesis of Materials

A series of samples were synthesised following the below protocol:
1) Dry 1 g of graphene platelets (i.e., host matrix, host structure) in an oven at 150° C. for 12 h.
2) Prepare 25 g of aqueous solution of ionic liquid in water at 10 wt % concentration: (2.5 g ionic liquid and 22.5 water—ionic liquids used in the present samples include ethyl-methylimidazolium methanesulfonate (EMIM CH₃SO₃) and Ethyl-methylimidazolium-chloride (EMIM Cl)).
3) Immerse the dried host matrix into the aqueous solution and stir it for 1 hr to attain a homogenous blend comprises graphene platelets and aqueous solution.
4) Leave the mixture to rest for one hour to ensure complete impregnation.
5) Filter the excess solution to separate the composite sorbent material.
6) Dry the composite in the oven at 150° C. for 1 hr to remove excess solvent (water).

To obtain further samples, steps 2-6 were repeated to impregnate fresh (un-impregnated) host matrix with ionic liquid in aqueous solutions having different concentrations of ionic liquid: 20 wt %, 30 wt%, 40 wt %.

The samples were named following the following naming conventions: GP-CL-X=graphene platelets impregnated with Ethyl-methylimidazolium-chloride in aqueous solution at X wt % concentration.

GP-CH3SO3-X=graphene platelets impregnated with ethyl-methylimidazolium methanesulfonate in aqueous solution at X wt % concentration.

### Quantification of Amount of Ionic Liquid in Samples

The wt % of ionic liquid of a number of the composite sorbent material samples was quantified according to the following equation:

$$IL content = \frac{{m}_{composite} - {m}_{dry matrix}}{{m}_{dry matrix}}$$

The amount of ionic liquid in the remaining samples was then calculated by extrapolated from the experimentally obtained results. The following results were obtained. * indicates results obtained from calculation by extrapolation.

| Sample | Ionic Liquid content (wt %) |
|---|---|
| GP-CL-10 | 2 |
| GP-CL-20 | 19 |
| GP-CL-30 | 30* |
| GP-CL-40 | 43* |
| GP- CH3SO3-10 | 3 |
| GP- CH3SO3-20 | 15 |
| GP- CH3SO3-30 | 25* |
| GP- CH3SO3-40 | 35* |

### Characterisation of Thermal Diffusivity

The thermal diffusivity of the samples was characterised as follows:

Laser flash thermal diffusivity analyser LFA 467 NETZSCH™ was used to determine the thermal diffusivity of the developed composites. The geometry of the sample holder used is that suggested in the equipment's user manual, comprising: (1) a sample holder plate, (2) lower support plate, (3) powdery sample, (4) upper support plate, and (5) fixing screw. The use of this kind of sample holder was chosen to provide a consistent measurement condition for all samples (a homogenised particle distribution compacted at a pressure of 0.1 MPa). The equipment is widely used in academia and industry that measures the thermal diffusivity at ±3% accuracy and ±2% repeatability. The sample mass typically ranges between 0.2 g and 0.7 g, the thickness of the sample ranges between 1.5 mm and 3 mm, and the packing density ranges between 0.6 and 1.4 g/cm³. These parameters are factored in determining the thermal diffusivity of the sample. The variation in the sample density is mainly depends on the salt concentration in the sample.

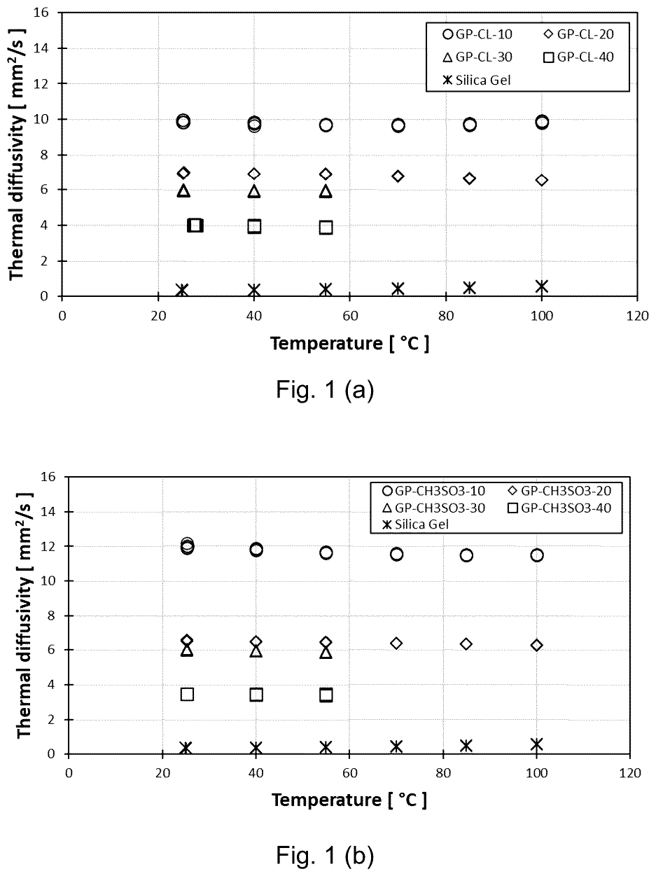

It was found that materials according to the present invention displayed remarkably good thermal diffusivity performance over a wide range of operating temperatures, as shown in FIG. 1(a) and FIG. 1(b), although thermal diffusivity was found to decrease with increasing ionic liquid concentration during impregnation.

The table below shows a summary of the measured thermal diffusivity for the developed composites developed from various salt concentrations (i.e. the concentration values given in the tables below are the concentration of the given ionic liquid in aqueous solution during wet impregnation of the 2D carbon allotrope) as measured at about 25° C. (i.e. corresponding to the leftmost plotted values in FIGS. 1(a) and 1(b). It can be seen from this data that the measured thermal diffusivity is much greater for material according to the present invention as compared with that of silica gel, indicating strong thermal performance of composites according to the present invention.

| | Thermal | | Thermal |
|---|---|---|---|
| | diffu- | | diffu- |
| | sivity | | sivity |
| | mm²/s | | mm²/s |
| | (see | | (see |
| EMIM CI | FIG. | EMIM CH3SO₃ | FIG. |
| concentration | 1(a)) | concentration | 1(b)) |
| 10 wt % [GP-CL-10] | 9.96 | 10 wt % [GP-CH3SO3-10] | 11.84 |
| 20 wt % [GP-CL-20] | 6.78 | 20 wt % [GP-CH3SO3-20] | 6.40 |
| 30 wt % [GP-CL-30] | 5.98 | 30 wt % [GP-CH3SO3-30] | 5.92 |
| 40 wt % [GP-CL-40] | 3.95 | 40 wt % [GP-CH3SO3-40] | 3.45 |

Silica gel benchmark = 0.443 mm²/s

Some further work was also done to compare the thermal diffusivity of materials according to the present invention with analogous materials using salt hydrates instead of ionic liquids. For this work, using the same graphene derivative host matrix impregnated with LiCl (a salt hydrate) at 20 wt % concentration yielded a composite having a thermal diffusivity of only 3.02 mm²/s as measured at about 25° C. As can be seen by comparison with the figures in the table above, the thermal diffusivity of analogous materials according to the present invention are found to be much higher than this, with GP-CH3SO3-20 displaying a thermal diffusivity of 6.4 mm²/s and GP-CL-20 a thermal diffusivity of 6.78 mm²/s at the same temperature and concentration (20%).

### Characterisation of Adsorption Characteristics

The adsorption characteristics of the samples was characterised as follows:

The sorption characteristics of the samples were determined using dynamic vapor sorption (DVS) gravimetric analyser DVS Resolution™ by Surface Measurements Systems. The accuracy of the DVS analyzer microbalance was verified ±0.05 mg by using 100 mg standard calibration mass prior to test execution. The adsorption characterisation included the rate of adsorption, the rate of desorption, heat of sorption and adsorption isotherms.

Sample was placed in the reaction chamber of the DVS for every test and was locally dried at room temperature by means of continuous flow of dry nitrogen gas at a rate of 200 sccm (standard cubic centimetre) until no change of the mass condition was reached. The mass at the end of the drying process was considered the dry mass (i.e., reference mass) for the following test to determine the change in sample mass. The drying process was followed by adsorption/desorption tests at various pressure ratios. The sample masses were recorded every 1 min to determine the adsorption kinetics at the predefined temperature and pressure ratio. It is noteworthy that the DVS utilizes Nitrogen as a carrier gas for the Ethanol vapor during the adsorption/desorption processes, as the effect of carrier gas on the adsorption kinetics is less than 10%, as reported by Rezk (2013).

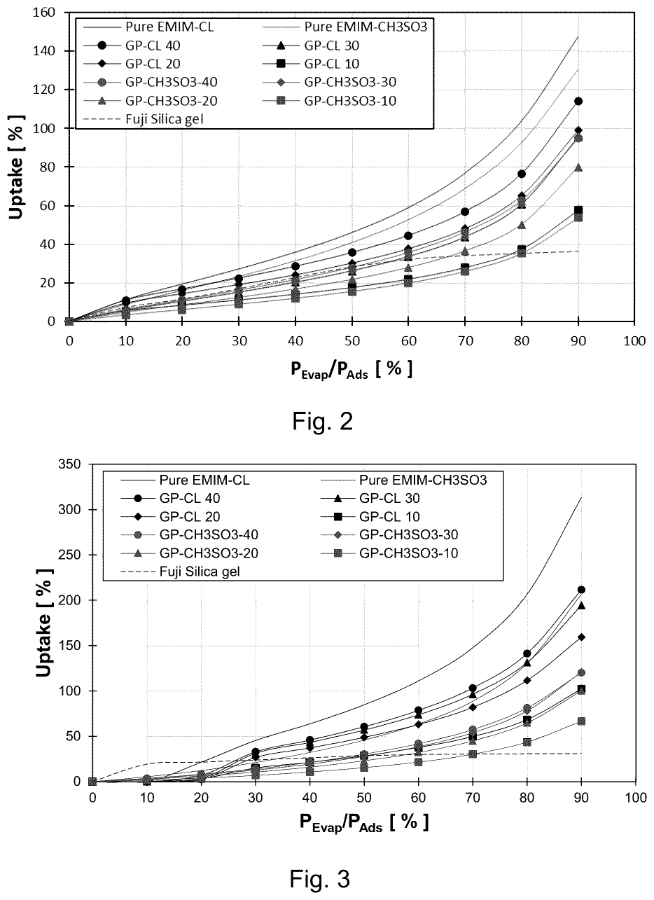

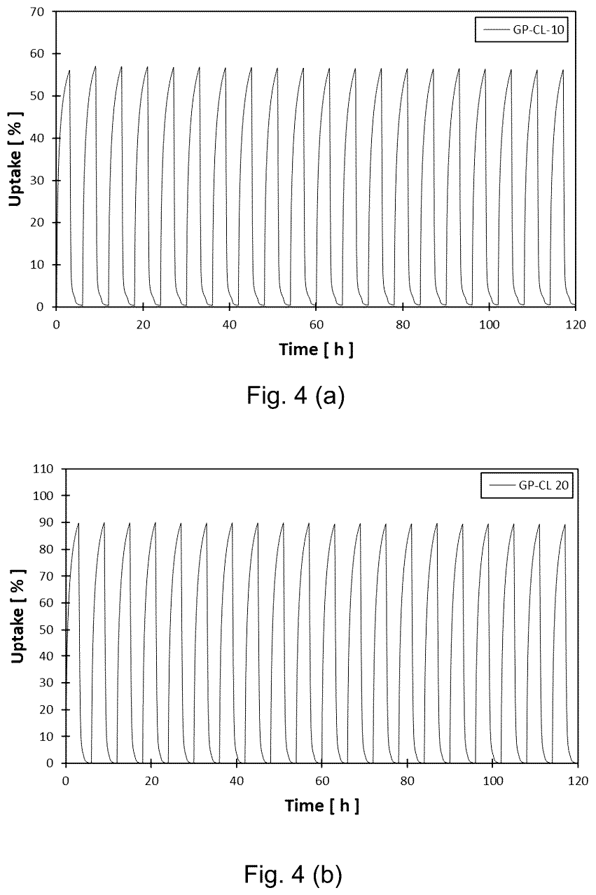

FIG. 2 shows water vapour adsorption characteristics of the developed composites compared to the conventionally used silica gel adsorbent. In particular from this graph it can be seen that the composites show a high sorption affinity to the water vapour adsorbate but vary according to chemical sorbent concentration during the impregnation; the higher the concentration, the higher the impregnated chemical sorbent and the better the adsorption performance.

The outstanding performance of the developed composite can be benchmarked against the silica gel. The table below shows the maximum equilibrium water uptake for the developed composites developed from various salt concentration (i.e. the concentration values given in the tables below are the concentration of the given ionic liquid in aqueous solution during wet impregnation of the 2D carbon allotrope). The maximum equilibrium uptake of silica gel RD benchmark (Fuji Silica-gel by Fuji Silysia Chemical Ltd) is 0.36 g_{water}/g_{silica gel}.

| | Maximum | | Maximum |
|---|---|---|---|
| | water | | water |
| | equilibrium | EMIM CH3SO₃ | equilibrium |
| EMIM CI | uptake | concen- | uptake |
| concentration | g_{water}/g_{ads} | tration | g_{water}/g_{ads} |
| 10 wt % [GP-CL-10] | 0.57 | 10 wt % | 0.54 |
| 20 wt % [GP-CL-20] | 0.99 | 20 wt % | 0.80 |
| 30 wt % [GP-CL-30] | 0.95 | 30 wt % | 0.95 |
| 40 wt % [GP-CL-40] | 1.14 | 40 wt % | 0.95 |
| 10 wt % | 1.02 | 10 wt % | 0.67 |
| 20 wt % | 1.59 | 20 wt % | 1.00 |
| 30 wt % | 1.94 | 30 wt % | 1.20 |
| 40 wt % | 2.12 | 40 wt % | 1.20 |

It can be seen from this data that the maximum equilibrium uptake g_{water}/g_{ads} and gₑₜₕₐₙₒₗ/g_{ads} is much greater than the maximum equilibrium uptake for silica gel for all samples tested, indicating strong sorption performance of composites according to the present invention.

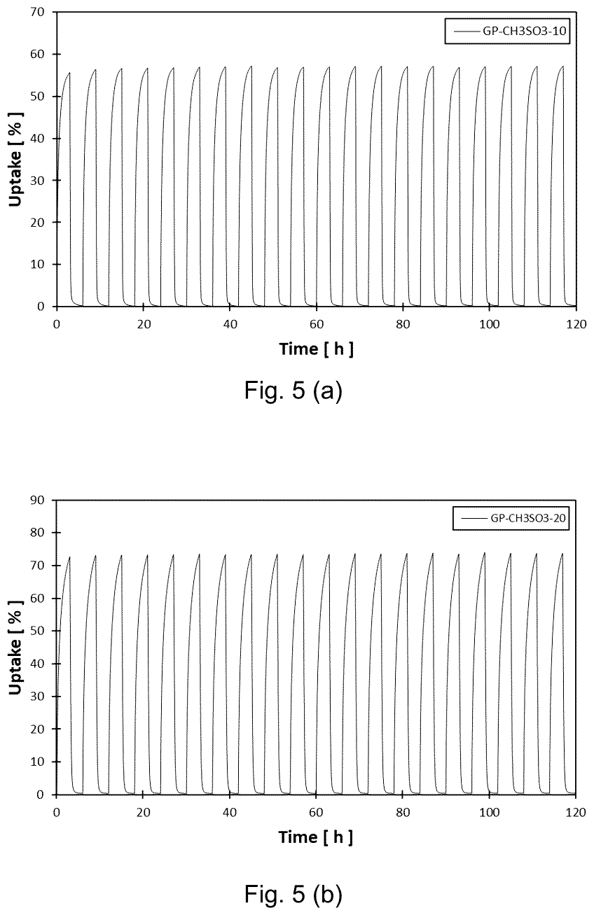

The stability of the water sorption capabilities of the samples was also tested, by varying the water vapor pressure ratio in the medium between 90% and 0% at 25° C. The results of this stability testing are shown in FIG. 4 and FIG. 5, which demonstrate that substantially no loss in the water uptake exists over 20 consecutive sorption/desorption cycles. Materials according to the present invention are therefore demonstrated to have excellent sorption stability.

### SEM Analysis

The samples were also analysed using SEM imaging. A small spatula of the sample was placed on double-sided copper tape glued to the microscope stub and placed in a Thermo Scientific™ Quattro S microscope equipped with a field emission filament (FEG).

An Everhart-Thornley (ETD) detector was used in the high vacuum to obtain images from secondary electrons at a magnification between 250 and 6500. The acceleration voltage for the beam was selected as 10 kV with spot size 3. This equipment and technique is widely used in academia and industry to visualise small scale objects.

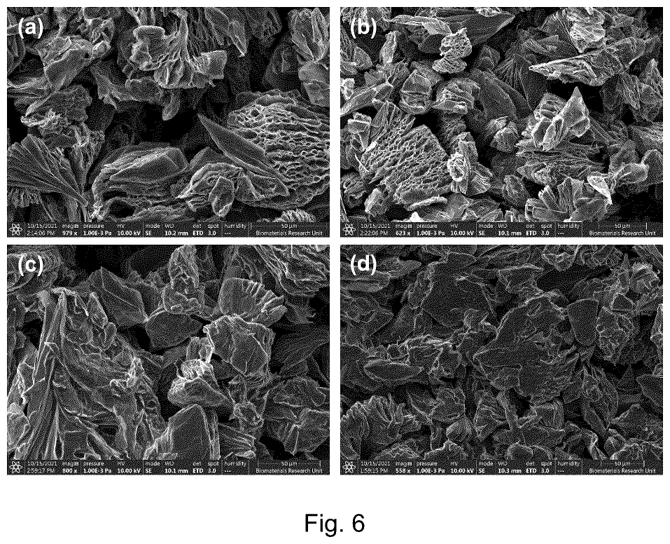

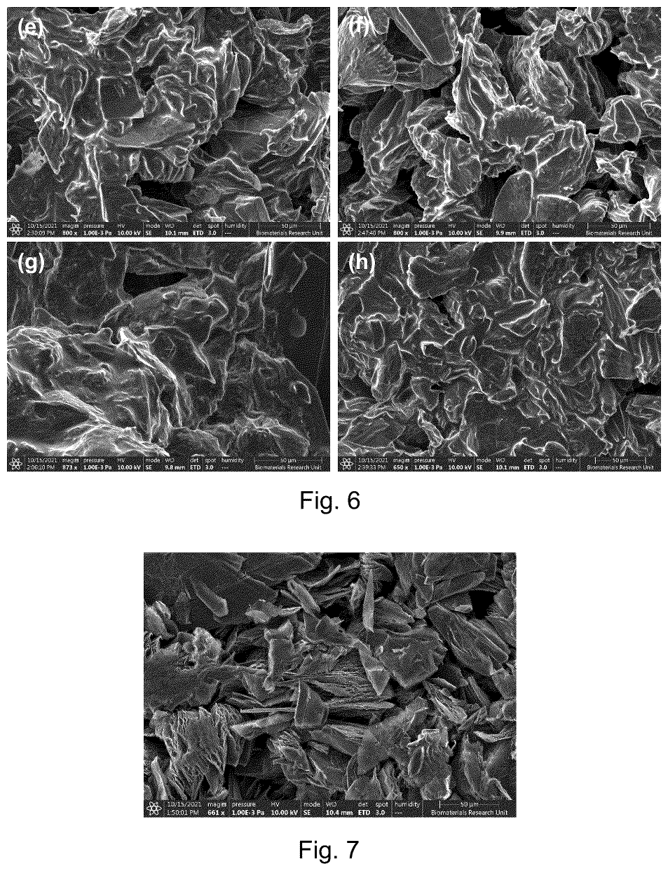

The resulting SEM images are shown in FIG. 6. FIG. 6 shows (a) GP-CL-10; (b) GP-CH3SO3-10; (c) GP-CL-20; (d) GP-CH3SO3-20; (e) GP-CL-30; (f) GP-CH3SO3-30; (g) GP-CL-40; (h) GP-CH3SO3-40. FIG. 7 shows for comparison an SEM image of pristine graphene platelets used to form composite materials according to the present invention.

The images demonstrate the degree of intercalating IL into graphene platelets at various wt % solutions compared with pristine platelets. It can be seen that at a low IL concentration of 10-20 wt %, the ILs are well confined into the interlayer spacing. At higher IL concentration of 30-40 wt %, excess IL precipitates on the external surfaces indicating a high level of interfacial deposition.

### Summary of Material Characterisation

From the above data and discussions, it can be seen that the thermal diffusivity was found to decrease with increasing ionic liquid concentration during impregnation of the 2D carbon allotrope, but that adsorption performance was found to increase with increasing ionic liquid concentration.

In view of this, it is considered that an optimal balance of amount of ionic liquid which provides good thermal diffusivity whilst retaining good sorption performance is achieved by impregnating the 2D carbon allotrope by immersion in a solution comprising ionic liquid in a concentration of from 20 wt % to 30 wt %, although materials formed from other wt % ionic liquid were nevertheless found to have satisfactory performance providing good utility for some applications.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.

Mehrkesh, Amirhossein & Karunanithi, Arunprakash. (2016). Optimal Design of lonic Liquids for Thermal Energy Storage. Computers & Chemical Engineering. 93. 10.1016/j.compchemeng.2016.04.008.

Gao, Jubao & Cao, Lingdi & Dong, Haifeng & Zhang, X. P. & Zhang, Suojiang. (2015). lonic liquids tailored amine aqueous solution for pre-combustion CO2 capture: Role of Imidazolium-Based lonic Liquids. Applied Energy. 154. 771-780. 10.1016/j.apenergy.2015.05.073.

Seo, Samuel & Quiroz-Guzman, Mauricio & Desilva, M & Lee, Tae & Huang, Yong & Goodrich, Brett & Schneider, William & Brennecke, Joan. (2014). Chemically Tunable lonic Liquids with Aprotic Heterocyclic Anion (AHA) for CO2 Capture. The journal of physical chemistry. B. 118. 10.1021/jp502279w.

Wang, L. W. & Metcalf, S. J. & Critoph, Robert & Thorpe, Roger & Tamainot-Telto, Zacharie. (2011). Thermal conductivity and permeability of consolidated expanded natural graphite treated with sulphuric acid. Carbon. 49. 4812-4819. 10.1016/j.carbon.2011.06.093.

Grekova, Alexandra & Gordeeva, Larisa & Aristov, Yuri. (2016). Composite sorbents “Li/Ca halogenides inside Multi-wall Carbon Nano-tubes” for Thermal Energy Storage. Solar Energy Materials and Solar Cells. 155. 176-183. 10.1016/j.solmat.2016.06.006.

Bonaccorso, Francesco & Lombardo, Antonio & Hasan, Tawfique & Sun, Zhipei & Colombo, Luigi & Ferrari, Andrea. (2012). Production and processing of graphene and 2d crystals. Materials Today. 15. 564-589. 10.1016/S1369-7021 (13)70014-2.

Andrea C Ferrari, Francesco Bonaccorso, Vladimir Fal'Ko, Konstantin S Novoselov, Stephan Roche, et al. Science and technology roadmap for graphene, related two-dimensional crystals, and hybrid systems. Nanoscale, Royal Society of Chemistry, 2014, 7 (11), pp.4598-4810.

Bourikas, K., Kordulis, C. & Lycourghiotis, A. 2006. The Role of the Liquid-Solid Interface in the Preparation of Supported Catalysts. Catalysis Reviews, 48, 363-444.

A. Rezk, R. AL-Dadah, S. Mahmoud, A. Elsayed, Investigation of Ethanol/metal organic frameworks for low temperature adsorption cooling applications, Applied Energy 112 (2013) 1025-1031

1. A composite sorbent material comprising a few-layer 2D carbon allotrope impregnated with an ionic liquid.

2. The composite sorbent material according to claim 1 wherein the 2D carbon allotrope comprises graphene, graphyne, graphyenylene, diamane, or mixtures thereof.

3. The composite sorbent material according to claim 1 wherein the 2D carbon allotrope has a thickness of between 1 and 10 atomic layers.

4. The composite sorbent material according to claim 1 wherein the ionic liquid comprises one or more salts having a melting point of 100° C. or less.

5. The composite sorbent material according to to claim 1 wherein the ionic liquid comprises one or more cations selected from the group consisting of: imidazolium, pyridinium, ammonium, phosphonium, or pyrrolodinium cations.

6. The composite sorbent material according to to claim 1 wherein the ionic liquid comprises one or more anions selected from the group consisting of: tetrafluoroborate [BF₄]⁻, hexafluorophosphate [PF₆]⁻, Chloride [Cl]⁻, Bromide [Br]⁻, Methylsulfate [CH₃OSO₃]⁻, methanesulfonate [CH₃SO₃]⁻, Trifluoromethanesulfonate [CF₃SO₃]⁻, bis(trifluoromethylsulfonyl) imide [(CF₃SO₂)₂N]⁻, Benzoate [C₇H₅O₂]⁻, Nitrate [NO₃]⁻, or Acetate [C₂H₃O₂]⁻ anions.

7. The composite sorbent material according to to claim 1 wherein the ionic liquid cation or anion comprises one or more aliphatic side chains groups selected from the group consisting of: methylene [CH₂], methyl [CH₃], ethyl [C₂H₅], propyl [C₃H₇], butyl [C₄H₉], Benzyl [C₆H₅CH₂], Methoxy [OCH₃], ethoxy [OC₂H₅], propoxy [OC₃H₇], butoxy [OC₄H₉], or hydroxyl [OH].

8. The composite sorbent material according to claim 1 wherein the ionic liquid is selected from 1-ethyl-3-methylimidazolium methanesulfonate (EMIM CH₃SO₃), 1-ethyl-3-methylimidazolium-chloride (EMIM Cl), 1-ethyl-3-methylimidazolium methyl sulfate (EMIM CH₃OSO₃), 1-ethyl-3-methylimidazolium trifluoromethanesulfonate (EMIM CF₃SO₃) or mixtures thereof.

9. The composite sorbent material according to claim 1 wherein the material is particulate in form.

10. The composite sorbent material according to claim 8 wherein the composite sorbent material has a particle size or agglomerated particles size in a range of from 5 to 70 μm.

11. The composite sorbent material according to claim 1 wherein the composite sorbent material has a thermal diffusivity of 3 mm²/s or more.

12. A method for producing a composite sorbent material according to claim 1, the method including steps of:
providing a few-layer 2D carbon allotrope; and
impregnating the 2D carbon allotrope with an ionic liquid to form the composite sorbent material.

13. The method according to claim 12 wherein the step of impregnating the 2D carbon allotrope with an ionic liquid is performed as one of: (i) a wet impregnation step; (ii) an incipient wetness impregnation step; or (iii) an equilibrium deposition filtration step.

14. The method according to claim 13 wherein the step of impregnating the 2D carbon allotrope with an ionic liquid is performed as a wet impregnation step, including a step of immersing the 2D carbon allotrope in an aqueous solution comprising the ionic liquid.

15. The method according to claim 14 wherein the concentration of the ionic liquid in the aqueous solution is in a range of from 10 wt % to 40 wt %, optionally from 20 wt % to 30 wt %.

16. A composite material comprising the composite sorbent material of claim 1 in combination with one or more further materials.

17. The composite material of claim 16 wherein the composite material comprises a metallic or graphite foam supporting the composite sorbet material of any one of claims 1 to 11

18. The composite material of claim 16 wherein the material is a coating material comprising the composite sorbent material according to any one of claims 1 to 11, in combination with a binder material.

19. The composite material of claim 18 wherein the binder material comprises polyvinyl acetate (PVA).

20. Use of a composite sorbent material according to claim 1 for thermal energy storage, sorption cooling, adsorption water desalination or air dehumidification.
